(19) United States
(12) Patent Application Publication
(10) Pub. No.: US 2016/0374314 A1
(43) Pub. Date: Dec. 29, 2016

(54) Pet Feeding Station

(71) Applicant: Lucy Kalian, Rumson, NJ (US)

(72) Inventor: Lucy Kalian, Rumson, NJ (US)

(21) Appl. No.: 14/746,935

(22) Filed: Jun. 23, 2015

(51) Int. Cl. A01K 5/01

(52) U.S. Cl. CPC A01K 5/0114

(57) ABSTRACT

A pet feeding station is provided that generally includes a top panel with apertures for receiving feeding bowls and a central aperture that receives no feeding bowl and feeding bowls received by the apertures Attached to the top panel are a front panel, a rear panel and two side panels. Because the central aperture does not receive a feeding bowl, a household animal with long ears can feed at the pet feeding station without having its ears come into contact with the contents of a feeding bowl, the ears passing through the central aperture or along a side of the feeding station.

### BACKGROUND OF THE INVENTION

Field of the Invention

The present disclosure relates to a pet feeding station, and more particularly to a pet feeding station that facilitates feeding of pets with long ears.

Related Art

Pet feeding stations are devices that allow owners of pets to provide food and water to the pets at a height that is preferable to both the owners and to the pets. Some pet feeding stations consist of a platform that supports at least one food bowl and legs that can be adjustable in height. This is beneficial to owners, particularly for those with back problems, in that it decreases the degree to which owners need to bend down to place food bowls on the floor. Placing the food bowls at an elevated height is also beneficial to the pet as this facilitates more comfortable feeding for the pet. Often, more than one food bowl is housed in the feeding station, allowing the owner to provide more than one type of food, or to feed multiple pets simultaneously.

Although current pet feeding stations are effective and perform their function adequately, they are not without drawbacks. For example, a pet feeding station of a fixed height cannot accommodate pets of various sizes or accommodate pets as they grow. Another drawback of current pet feeding stations is that they do not accommodate pets with ears that are long enough to come into contact with the contents of the food bowls that such pets are feeding from. This can be particularly frustrating for some pet owners as this increases the time that the owner needs to spend cleaning the pet and increases the frequency at which the owner may need to pay for grooming and other pet care services.

Therefore, there remains a need to provide a pet feeding station that is adjustable in height and that allows a pet having long ears to feed at the station while preventing contact of the pet's ears with water and/or food.

### SUMMARY OF THE INVENTION

The present disclosure relates to a pet feeding station. The feeding station comprises a feeding stand and a plurality of feeding bowls. The feeding stand includes a top panel with apertures for receiving the feeding bowls and a central aperture positioned between the apertures that receive the feeding bowls. Attached to the top panel are a front panel, a rear panel and two side panels. Legs can be integrally formed with front panel, rear panel and side panels, or the legs can be formed separately and later attached to the panels. The feeding bowls are received by the apertures in the top panel, and each includes a lip that extends outwardly from the top of the feeding bowl to support the feeding bowl in a respective aperture by resting on the top panel. Because the central aperture does not receive a feeding bowl, a pet with long ears can feed at the pet feeding station without having its ears come into contact with the contents of a feeding bowl.

To further prevent a pet's ears from coming into contact with the contents of a feeding bowl, the apertures for receiving the feeding bowls, and the feeding bowls themselves, can include tapered walls/edges. Still further, tapered side walls matching the curvature of the apertures and the feeding bowls can be provided on the top panel of the feeding station, thus increasing the likelihood that the pet's ears will pass on either side of the feeding bowl.

The pet feeding station could also include adjustable legs. The adjustable legs could each include a lower leg member, an adjustment hinge hingedly attached to the lower leg member, and a torsion spring disposed between the lower leg member and the adjustment hinge. The adjustable legs are slidably received by channels formed in upper leas of the feeding station. The adjustable legs can be slidably adjusted by depressing the adjustment hinges, extending or retracting the legs to desired positions, aligning the adjustment hinge tips with apertures provided along sides of the station, and releasing the adjustment hinges to engage the tips of the adjustment hinges with the apertures and fixing the positions of the lower leg member.

### BRIEF DESCRIPTION OF THE DRAWINGS

The foregoing features of the disclosure will be apparent from the following Detailed Description of the Invention, taken in connection with the accompanying drawings, in which:

FIG. 1 is a perspective view showing the pet feeding station of the present disclosure;

FIG. 2 is a top view of the pet feeding station of FIG. 1;

FIG. 3 is a partial cross-sectional view (taken along line 2-2 of FIG. 2) showing placement of the feeding bowls of the pet feeding station of FIG. 1;

FIG. 4 is a top view showing another embodiment of the pet feeding station;

FIG. 5 is a perspective view showing a feeding bowl of the pet feeding station of FIG. 4;

FIG. 6 is a partial front cross-sectional view showing another embodiment of the pet feeding station;

FIG. 7 is a partial side view showing the pet feeding station of FIG. 6; and

FIG. 8 is a partial cross-sectional view (taken along line 8-8 of FIG. 6) showing an extending configuration for the legs of the pet feeding station of FIGS. 6-7.

### DETAILED DESCRIPTION OF THE INVENTION

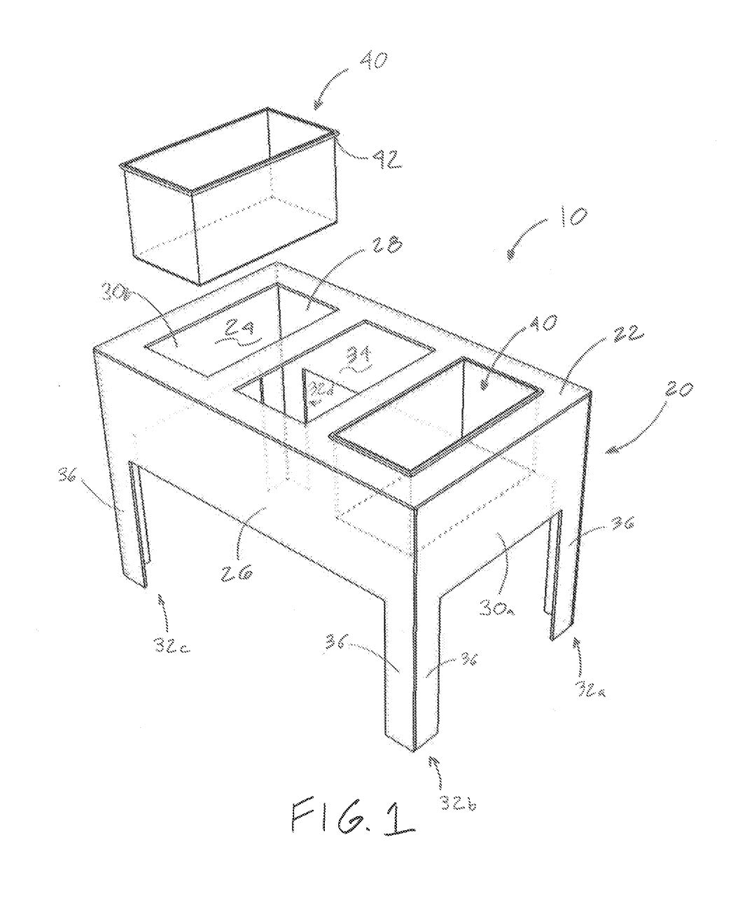

The present disclosure relates to a pet feeding station, as discussed in detail below in connection with FIGS. 1-8.

FIG. 1 is a perspective view showing the pet feeding station of the present disclosure, indicated generally at 10. The pet feeding station 10 comprises a feeding stand indicated generally at 20 and feeding bowls 40. The feeding stand 20 includes top panel 22, front panel 26, rear panel 28, and side panels 30a, 30b.

The top panel 22 is rectangular in shape. Bowl apertures 24 are provided in top panel 22 and a central aperture 34 is provided in top panel 22 at a location between bowl apertures 24. Bowl apertures 24 are sized to receive feeding bowls 40. Central aperture 34 does not receive a feeding bowl. This a pet with long ears to feed at the pet feeding station 10 while preventing its ears from contacting the contents of either feeding bowl 40, such that the ears pass through central aperture 34 and along a side 30a or 30b. Central aperture 34 can be sized to optimize this advantage. Top panel 22 could be formed from any suitably strong and lightweight material, such as aluminum, plastic, etc.

Front panel 26 and rear panel 28 are disposed along each of the longer sides of top panel 22 as shown in FIG. 1. Side panels 30a, 30b are disposed along the shorter sides of top panel 22. As can be seen in the figures, front panel 26, rear panel 28, and side panels 30a, 30b can include elongated rectangular leg portions 36, such that adjacent leg portions 36 form legs 32a-32d integrally formed with front panel 26, rear panel 28, and side panels 30a, 30b when assembled in the configuration of FIG. 1. Front panel 26, rear panel 28, and side panels 30a, 30b could be formed from any suitably strong and lightweight material, such as aluminum, and can be secured to top panel 22 by way of welding, riveting, bolting, or any other suitable process known to the art. Adjacent leg portions 36 of front panel 26, rear panel 28, and side panels 30a, 30b can also be secured to each other by way of a similar process to provide structural strength. Feeding stand 20 could also be formed from plastic, as a unitary construction, by injection molding, compression molding, or any other suitable plastic molding process known to the art.

Of course, it is noted that legs 32a-32d need not be formed integrally with front panel 26, rear panel 28, and side panels 30a, 30b and could be formed separately and subsequently attached thereto (e.g., by forming the legs 32a-32d as separate components and then joining the legs 32a-32d together with the feeding stand 20 via welding, riveting, bolting, or any other suitable process known to the art).

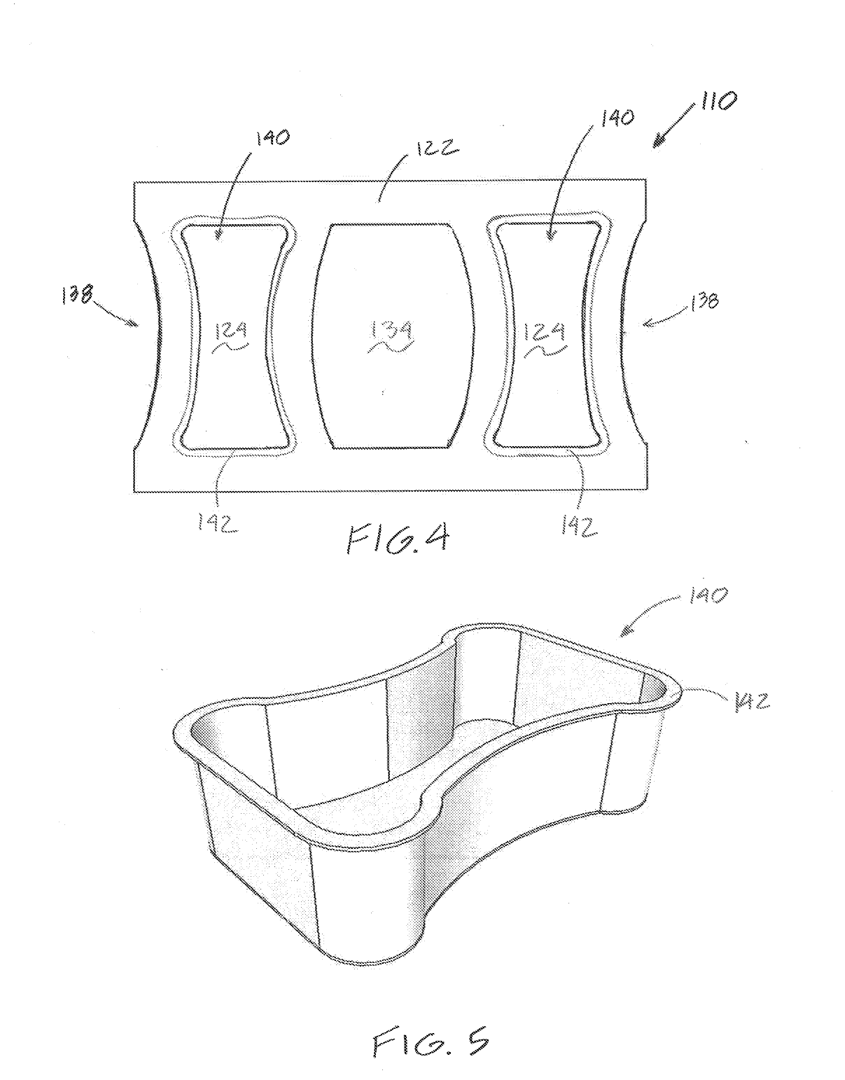

Feeding bowls 40 are received through bowl apertures 24 in top panel 22, each feeding bowl 40 including lip 42 that extends outward from the top of the feeding bowl 40. The feeding bowls 40 could be formed from any material that provides the suitable strength and anti-corrosive properties necessary for a food container, such as stainless steel, plastic, etc. It is noted that feeding bowls 40 and bowl apertures 24 need not be formed in a rectangular shape as depicted in FIG. 1, above. In other embodiments, feeding bowls 40 and bowl apertures 24 could be formed in other shapes such as those shown in FIGS. 4-5 (discussed below).

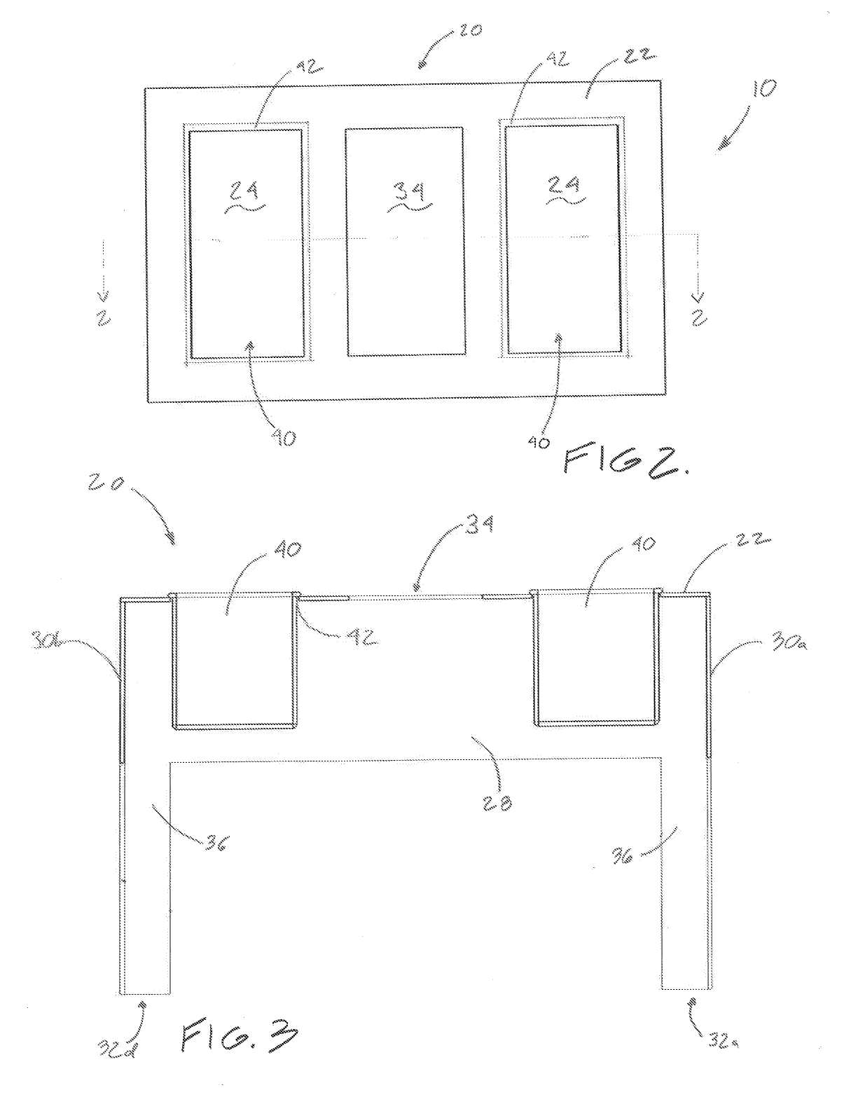

FIGS. 2-3 show the placement of the feeding bowls 40 in the feeding stand 20 of the pet feeding station of the present disclosure. As seen in FIG. 3, a partial cross-sectional view (taken along line 2-2 of FIG. 2), feeding bowls 40 are received through bowl apertures 24 and are each supported by way of a lip 42 that rests on the top surface of top panel 22 as depicted in FIGS. 1 and FIG. 3.

FIGS. 4-5 show another embodiment of the pet feeding station of the present disclosure. FIG. 4 is a top view showing pet feeding station 110 of the present disclosure. The pet feeding station 110 includes a top panel 122, and feeding bowls 140. Top panel 122 is provided in a generally rectangular shape with bowl apertures 124 through top panel 122 and central aperture 134 through top panel 122 at a location between bowl apertures 124. Bowl apertures 124 have a slight inward curvature (taper) that gives the bowl apertures 124 a “dog bone” shaped appearance. Additionally, bowl apertures 124 are sized to receive feeding bowls 140. Central aperture 134 has a slight outward (convex) curvature that can be complimentary to the inward (concave) curvature of bowl apertures 124. Central aperture 134 does not receive a feeding bowl 140. Further, tapered side walls 138 that compliment the inward taper of apertures 124 can be provided on top panel 122. This provides the advantage of allowing a pet with long ears to feed at the pet feeding station 110 while preventing contact of the pet's ears with the contents of either feeding bowl 140, given that one ear passes through central aperture 134 and the other along a side of the feeding station 110. Top panel 122 could be formed from any suitably strong and lightweight material, such as aluminum, plastic, etc.

FIG. 5 is a perspective view of a feeding bowl 140 of the pet feeding station of the present disclosure. Feeding bowls 140 are received through bowl apertures 124 in top panel 122, and have a slight inward curvature that give the feeding bowls 140 a “dog bone” shaped appearance. Each feeding bowl 140 includes a lip 142 that extends outward from the top of the feeding bowl 140, The lips 142 provide support for the feeding bowls 140 when they are received through the feeding bowl apertures 124, such that the lips 142 rest on the top surface of top panel 122. The feeding bowls 140 can be formed from any material that provides the suitable strength and anti-corrosive properties necessary for a food container, such as stainless steel, plastic, etc.

FIGS. 6-8 show another embodiment of the pet feeding station of the present disclosure. Pet feeding station 210 includes feeding stand 220, telescoping leg portions 250, and feeding bowls 240. The feeding stand 210 includes top panel 222, front panel 226, rear panel 228, and side panels 230a, 230b. Top panel 222 is provided in a rectangular shape. Bowl apertures 224 are provided in top panel 222, and central aperture 234 is provided in top panel 222 at a location between bowl apertures 224. Bowl apertures 224 are sized to receive feeding bowls 240. Central aperture 234 does not receive a feeding bowl. Top panel 222 could be formed from any suitably strong and lightweight material, such as aluminum, plastic, etc.

Front panel 226 and rear panel 228 are disposed along each of the longer sides of top panel 222. Side panels 230a, 230b are disposed along the shorter sides of top panel 222. As can be seen in the figures, the feeding station 220 includes upper leg portions 236, which could be formed integrally with the panels 226, 228, and 230a, 23b. Adjacent upper leg portions 236 form upper legs 232a-232d integrally with front panel 226, rear panel 228, and side panels 230a, 230b. The side panels 230a, 230b include a plurality of spaced apertures 258 arranged adjacent to extending leg portions 250 as shown in FIG. 7. Front panel 226, rear panel 228, and side panels 230a, 230b could be formed from any suitably strong and lightweight material, such as metal, plastic, etc., and can be secured to top panel 222 by way of welding, riveting, bolting, or any other suitable process known to the art. Adjacent upper leg portions 236 of front panel 226 and rear panel 228 can also be secured to adjacent upper leg portions 236 of side panels 230a, 230b by way of a similar process to provide greater structural strength.

Feeding bowls 240 are shaped to extend through bowl apertures 224 in top panel 222. Each feeding bowl 240 includes a lip 242 that extends outward from the top of the feeding bowl 240. The lips 242 provide support for the feeding bowls 240 when they are received through the feeding bowl apertures 224, such that the lips 242 rest on the top surface of top panel 222. The feeding bowls 240 could be formed from any material that provides the suitable strength and anti-corrosive properties necessary for a food container, such as stainless steel.

Extendable telescoping leg portions 250 are adjustable in the direction of arrow A, as shown in FIG. 7. As shown in FIG. 6, the leg portions 250 each include a lower leg member 254 and a bumper 262. Additionally, a suitable locking mechanism for locking each of the lower leg members 254 could be provided, such as adjustment hinge 256 and torsion spring 260. Adjustment hinge 256 can be hingedly affixed to lower leg member 254 by way of welding, riveting, bolting, or another suitable process. Torsion spring 260 is disposed between lower leg member 254 and adjustment hinge 256, providing resistance against adjustment hinge 256 when it is depressed and returning adjustment hinge 256 to its home position when released. Bumpers 262 are disposed on the bottom of lower leg members 254, providing the pet feeding station 210 with additional stability and protecting the surface on which the pet feeding station 210 rests.

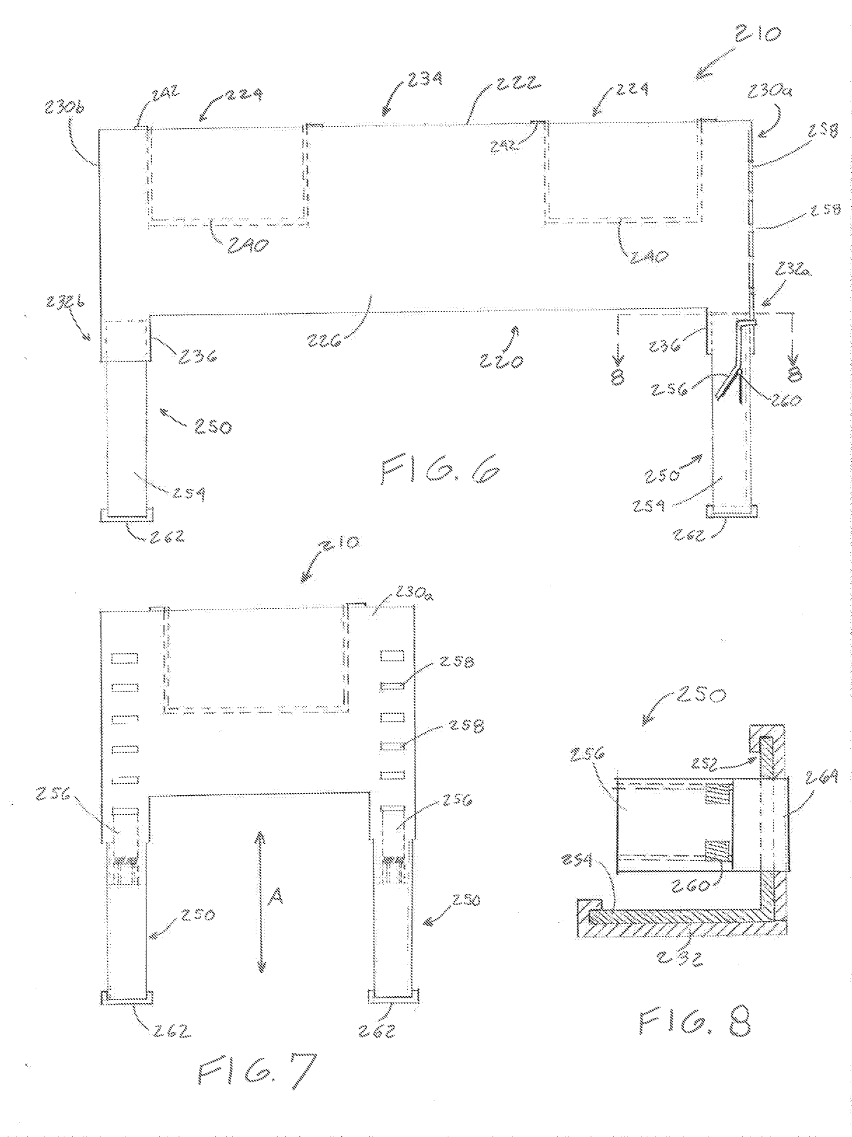

FIG. 8 is a partial cross-sectional view taken along line 8-8 of FIG. 6. As can be seen in the figure, the upper legs 232 can be shaped to provide channels 252 for slidably receiving lower leg members 254. When aligned with an aperture 258, a tip 264 of adjustment hinge 256 can be received by the aperture 258. When adjustment hinge 256 is depressed, the tip 264 does not engage apertures 258, and lower leg member 254 can slidably move relative to upper leg 232. When the adjustment hinge 256 is released, torsion spring 262 biases adjustment hinge 256 to its home position, causing tip 264 to extend through an aperture 258, and fixing the position of lower leg member 254. Thus, by depressing adjustment hinge 256, raising or lowering the leg 254 to a desired height, aligning tip 264 with an aperture 258, and releasing adjustment hinge 256, a user may easily adjust the height of each leg of the pet feeding station 210.

Of course, it is noted that the pet feeding stand of the present disclosure is not limited to lower leg member 254, adjustment hinge 256, apertures 258, and torsion spring 260, and could instead include any other suitable locking mechanism, For example, in place of adjustment hinge 256 and torsion spring 260, described above, the pet feeding stand could include a spring-biased button/detent, a flexible tab, a twist-lock mechanism, another slot and pin system, or another suitable means for fixing the position of the legs 254. Additionally, the pet feeding stand could include telescopic legs having rectangular cross-sections, or any other configuration of suitably strong collapsible leg members.

Having thus described the disclosure in detail, it is to be understood that the foregoing description is not intended to limit the spirit or scope thereof. What is desired to be protected is set forth in the following claims.

What is claimed is:

1. A pet feeding station, comprising:
a feeding stand including a top surface having a plurality of apertures;
a plurality of legs attached to the feeding stand; and
at least two feeding bowls extending through at least two of the plurality of apertures, wherein a third aperture of the plurality of apertures is positioned between the at least two of the plurality of apertures and does not include a feeding bowl, and wherein one of the pet's ears extends through the third aperture when the pet feeds at either of the at least two feeding bowls.

2. The pet feeding station of claim 1, wherein the plurality of legs are formed integrally with the pet feeding station.

3. The pet feeding station of claim 1, wherein the plurality of legs are telescopically extendable to adjust the height of the feeding station.

4. The pet feeding station of claim 3, further comprising a locking mechanism for locking the plurality of legs.

5. The pet feeding station of claim 4, wherein the locking mechanism further comprises an adjustment hinge, a torsion spring, and a plurality of apertures in the side of the pet feeding station.

6. The pet feeding station of claim 1, wherein the feeding bowls comprise lips that extend outwardly from the tops of the feeding bowls and support the feeding bowls on the top surface of the pet feeding station.

7. The pet feeding station of claim 1, wherein the feeding bowls each include inwardly curving sidewalls.

8. The pet feeding station of claim 7, wherein the feeding station includes inwardly curving sidewalls.

9. A pet feeding station, comprising:
a feeding stand including a top surface having a plurality of apertures;
a plurality of telescopically extendable legs attached to the feeding stand;
at least two feeding bowls extending through at least two of the plurality of apertures, wherein a third aperture of the plurality of apertures is positioned between the at least two of the plurality of apertures and does not include a feeding bowl, and wherein one of the pet's ears extends through the third aperture when the pet feeds at either of the at least two feeding bowls.

10. The pet feeding station of claim 9, further comprising a locking mechanism for locking the plurality of legs.

11. The pet feeding station of claim 10, wherein the locking mechanism further comprises an adjustment hinge, a torsion spring, and a plurality of apertures in the side of the pet feeding station.

12. The pet feeding station of claim 9, wherein the feeding bowls comprise lips that extend outwardly from the tops of the feeding bowls and support the feeding bowls on the top surface of the pet feeding station.

13. The pet feeding station of claim 9, wherein the feeding bowls each include inwardly curving sidewalls.

14. The pet feeding station of claim 13, wherein the feeding station includes inwardly curving sidewalls.
